(19) United States
(12) Patent Application Publication
(10) Pub. No.: US 2006/0176394 A1
(43) Pub. Date: Aug. 10, 2006

(54) De-interlacing of video data

(76) Inventor: Paolo Giuseppe Fazzini, Watford (GB)

Correspondence Address: FLYNN THIEL BOUTELL & TANIS, P.C., 2026 RAMBLING ROAD, KALAMAZOO, MI, 49008-1631, US

(21) Appl. No.: 11/125,416

(22) Filed: May 9, 2005

(30) Foreign Application Priority Data
Feb. 4, 2005 (GB) 0502375.9

(51) Int. Cl. H04N 11/20

(52) U.S. Cl. 348/448

(57) ABSTRACT

A method and apparatus are provided for converting an interlaced video signal to a non-interlaced video signal. For each pixel in each missing line of a video field in a video signal, correlation data is derived for each of a set of possible interpolations to be used in reconstructing pixels in each missing line (12). A correlation is selected (14) corresponding to the interpolation scheme likely to give the best result for a missing pixel, and an interpolation scheme selected (16) in dependence on the selected correlation. The pixel in the missing line is then interpolated (18). The step of deriving correlation data uses both the field containing the missing line and adjacent fields.

### BACKGROUND TO THE INVENTION

This invention relates to a method and apparatus for de-interlacing or scan converting an interlaced video signal to a progressive scan or de-interlaced video signal.

Broadcast television signals are usually provided in an interlaced form. For example, the phase alternate line (PAL) system used in Europe is made of video frames comprising two interlaced fields. Each field comprises alternate lines of the frame. Thus when the signal is applied to a display, the first field will be applied to the odd numbered lines of the display followed by the second field being applied to the even numbered lines of the display. Frame rate, the rate at which frames comprising two interlaced fields are applied to a display is usually 50 Hz, and therefore the field rate is 100 Hz. Thus, if each field is converted to whole frame of video data, i.e. the missing lines in each field are somehow generated, the effective frame rate will be 100 Hz. It also has the advantage of increasing the resolution of the television picture.

In U.S. Pat. No. 5,532,751, a method is disclosed for evaluating the variation between pixels in an image to detect edges or contours. If the variation between pixels is below a threshold, then the orientation of an edge is estimated and a new pixel is formed from the average of the pixel's line along the estimated orientation. If the estimate of edge orientation is unsuccessful then a new pixel is formed from the average of two vertically aligned pixels with respect to the pixel to be derived. This technique has the drawback that it can generate visible artefacts in pixels which have two or more pairs of pixels with a high mutual resemblance.

An improvement on this method is described in U.S. Pat. No. 6,133,957. In this, the variation between pixels or a set of pixels is computed to reconstruct borders. Two variations are chosen among those with the smallest values and the pixel to be reconstructed is generated as a weighted average of the pixels which produce the selected variations. Again, this technique can cause visible artefacts in very detailed scenes. These can be even more noticeable when the amount of motion in the scene is low. In our British patent application no. 2402288, a solution is proposed. In this, the vertical frequencies present in the image data are preserved for de-interlacing when clear information on borders is not available.

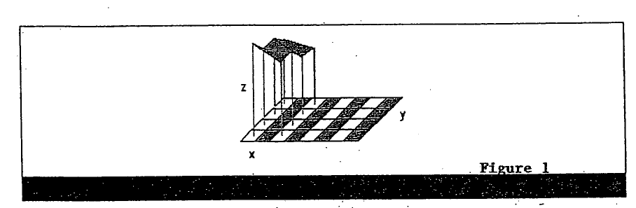

The problem of de-interlacing can be appreciated from FIG. 1 in which a plot of the colour (luminance) of the pixels with respect to their position within the frame is shown. X and Y are the co-ordinates of a pixel and Z is the pixel luminance. The white stripes in the X plane represent the lines of pixels for which data is available from a field and the grey stripes represent the missing lines i.e. the lines to be reconstructed. The grey projected surface in the Z axis is the luminance values of the known pixels with a surface interpolated between the known values. In de-interlacing, or finding the values of the pixels in the missing lines, an attempt is made to increase the resolution of this projected surface.

All the techniques discussed above for border reconstruction share the common feature of retrieving input data from one instant of time. The missing information is then reconstructed in the surface of FIG. 1 using data from one instant of time only, i.e. from the current field.

Other methods have been proposed to de-interlace video data using also temporal information. The best known of these are motion compensation-based schemes. In all these schemes which use motion compensation, the purpose is to detect the movement of many objects in a scene and translate this movement into time. Such an approach is particularly effective when the motion present is mainly translational for example when deformations and rotations are slow enough to be well approximated with substantially straight translations over a small number of fields.

The problem with motion compensation techniques is that in some cases even slow-moving objects can present a degree of deformation or rotation which is capable of yielding reconstruction problems. This can result in flickering or high vertical frequencies even in static scenes. These types of visible artefacts are particularly noticeable to a viewer.

In static or almost static scenes where visible artefacts such as these appear, reconstruction methods based on information coming from one instant of time only (one field) such as a border reconstructor are unable to give good performance. Furthermore, techniques based on motion compensation do not provide sufficiently good results when objects which are deforming are in the scene and more generally when the motion cannot be efficiently approximated with translation vectors.

Preferred embodiments of the present invention provide a geometric approach to the reconstruction or interpolation of pixels of missing lines as a video field which performs very effectively with slow motion.

More particularly, if we consider the situation of FIG. 1 where the surface represented relies exclusively on spatial data, then the object of the border reconstruction procedure is to refine the surface by finding the best compromise between frequencies and accuracy. Ideally, the reconstruction will yield a surface which contains higher spatial frequencies than the input field (the grey lines extended in the Y axis) whilst avoiding artefacts which are not present in the input surface. For instance, if an input surface is substantially constant with timing fluctuations, an output surface of the type shown in FIG. 1 with a large spike in it will not generally be an acceptable output.

### SUMMARY OF THE INVENTION

In accordance with an embodiment of the present invention there is provided a generalised approach to border reconstructors using spatial and temporal data. Thus, this system uses data from the current field as well as from at least the adjacent fields.

### DETAILED DESCRIPTION OF THE DRAWINGS

A preferred embodiment of the invention will now be described in detail by way of example with reference to the accompanying drawings in which:

FIG. 1 shows the projected surface discussed above;

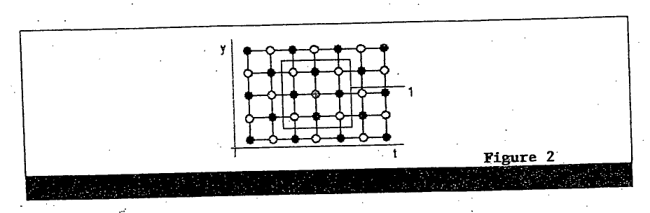

FIG. 2 shows in the vertical and time directions, the positions of lines and missing lines on a number of successive fields on image data;

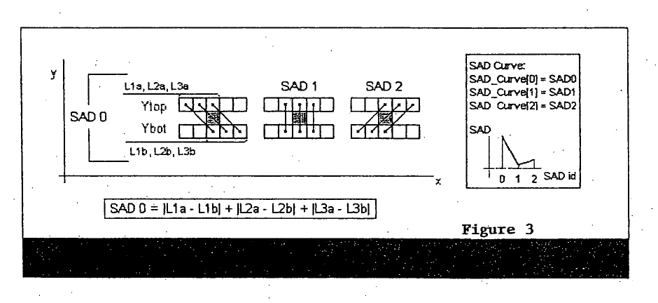

FIG. 3 shows schematically the type of analysis which is made when determining how best to interpolate missing pixels in a single field;

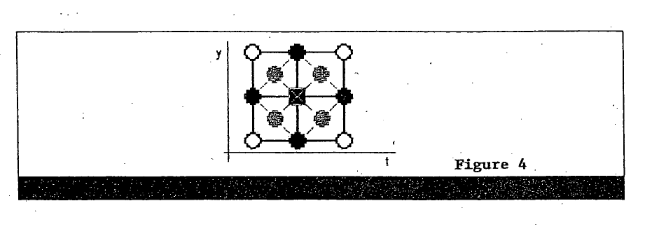

FIG. 4 shows in the vertical and time directions, the positions of additional data points which may be generated for use in interpolating missing pixels;

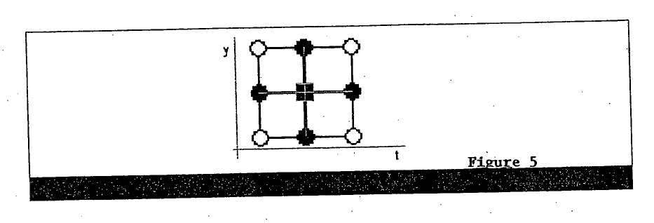

FIG. 5 shows an alternative selection of data points for use in interpolating missing pixels; and

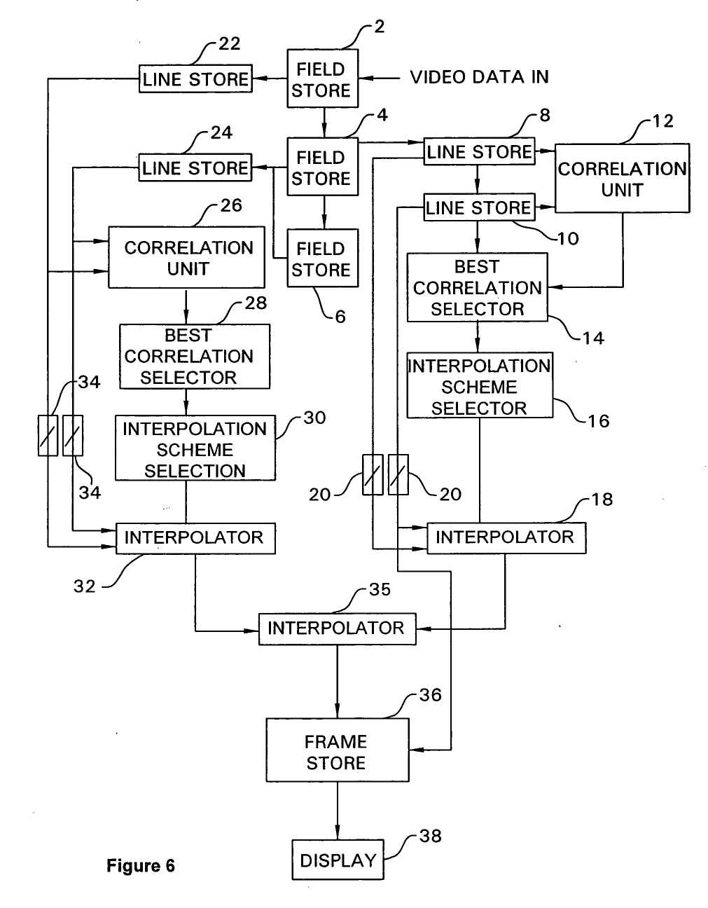

FIG. 6 shows a block diagram of an embodiment of the invention.

### DETAILED DESCRIPTION OF THE PREFERRED EMBODIMENT

In the arrangement of FIG. 3, three different possible interpolation schemes are shown and correlations are evaluated for these. The middle scheme shown comprises correlation of the data and pixels above and below the pixel to be reconstructed and correlation data between pairs of pixels immediately adjacent to this. A further interpolation is evaluated in the left hand example of FIG. 1 by looking at the correlation between pixels on lines which pass diagonally sloping down to the right through the pixel being reconstructed. The same process with the opposite diagonals is shown in the right-hand example of FIG. 3.

The correlation between the data and the various pairs of pixels can be derived using the sum of absolute differences (SAD) or the mean square error (MSE), or other well-known statistical techniques. The sum of absolute differences and the means square error are determined in a well-known manner.

The input to the SAD and MSE derivations are the luminances of the pixels in the lines above and below the pixel to be reconstructed in a field.

The graph on the right-hand side of FIG. 3 shows an example of SAD based procedure using five pixels only for each row and three correlations of symmetrically located sets of pixels, each made up of three pixel pairs. In practice, more pixels are involved in the computation to ensure greater accuracy. Preferably between seven and thirty pixel pairs are used.

If the SAD approach to comparing the values of pairs of pixels is used then FIG. 3 needs three SAD values, SAD 0, SAD 1 and SAD 3 which are shown graphically at the right-hand side of FIG. 3. This is the correlation curve for the various possible interpolation schemes. In many techniques, the interpolation scheme which gives the smallest difference in SAD or the smallest MSE is used for the interpolation, although in practice it does not always give the best answer.

Turning now to FIG. 4, this shows a small portion of three consecutive fields in the vertical direction against time. Thus, the central field has data present on the upper and lower pixels and a missing pixel to be reconstructed in the central position. The adjacent fields have no data on the upper and lower lines but do on the central line.

Using the arrangement of FIG. 3 with FIG. 4, would involve making the correlation for only the current field, i.e. the central field.

The embodiment of the present invention also uses the data from adjacent fields. This can be used in the manner shown in FIG. 4 by generating additional data points shown in grey between the two fields. Each of these is generated from the nearest pair of two pixels which carry data in the fields between which it falls. Thus, the four pixels which are to be used in determining how best to generate the missing pixel are first used to generate data points on lines between their positions. These are average values. The correlation process of FIG. 3 can then be performed on each diagonally opposed pair of new data points for each pixel in each line of the image. This will then produce two sets of correlation data for each pixel to be reconstructed. The correlation data which indicates the best chance of generating a closely correct value for the missing pixel is then selected from each set of correlation data and an interpolation scheme corresponding to that correlation selected for interpolation of the missing pixel for each set of correlation data. If the correlation analysis is an SAD analysis, then the correlation which gives the lowest value of SAD will be selected to determine the interpolation scheme.

When the best interpolation scheme from each SAD set of data has been selected and the missing pixel data interpolated, using each of the two selected schemes, and then interpolate between the results from the two schemes to give the resultant output. If more vertically or temporally-spaced pixels are used as input, and more correlations are performed then this can be extended by forming an interpolation between the two or more interpolation schemes determined by the correlation data to produce the best resultant data for a missing pixel.

An alternative scheme is shown in FIG. 5. In this, rather than constructing mid points between the lines, the correlations are performed on the vertically adjacent lines and on the temporally adjacent lines from adjacent fields. This avoids the need for any additional circuitry for generation of mid points and in most cases gives good results.

In either the example of FIG. 4 or FIG. 5, the interpolation and correlation schemes could be expanded to take account of lines and fields which are further spaced from the pixel to be reconstructed. In some cases, this will improve the quality of the reconstructed image.

By using this approach, a coherent continuity is given to the space time surface around the pixel to be reconstructed.

FIG. 6 shows a block diagram of a system appropriate for implementing the scheme shown in FIG. 5. This can be modified with the addition of extra units to generate the mid points and FIG. 4.

Input video data is fed through three field stores, 2, 4, and 6. Field store 4 contains the field with the missing lines which are to be reconstructed, referred to as the current field. Thus, at the start of the video sequence, a first field will be fed to field store 2, then to field store 4, then to field store 6 and processing will commence. The process will continue with fields moving from field store 2 to field store 4, field store 4 to field store 6, and the next field in the sequence being fed to field store 2.

Data is read out from field store 4 to a first line store 8 and then to second line store 10. Thus, a line is first read by line store 8 passed to line store 10, and a second line fed to line store 8. The two line stores then contain the two immediately adjacent lines to the missing line in the current field.

Next, for each pixel in turn to be reconstructed for the field in field store 4, a correlation unit 12 performs a sequence of correlations for the different interpolations which may be used to generate the missing pixel. This is done in a manner similar to that illustrated in FIG. 3 but with more interpolation schemes being used to produce correlations. The resultant correlation data is fed to the best correlation selector 14 which selects the correlation likely to give the best interpolation scheme for generating the missing pixel. The output of this is then used by an interpolation scheme selector 16 to select the interpolation which corresponds to the correlation selected by the best correlation selector 14. This correlation scheme is then loaded into an interpolator 18. This also receives data from the line stores 8 and 10 after any necessary delays 20. Thus the interpolator receives the pixel data required to perform the interpolation for the missing pixel.

At the same time, a line from each of field stores 2 and 6 are read to further line stores 22 and 24 respectively. These comprise the lines which are spaced in time by one field from the line which is being reconstructed.

In a similar manner to the process applied to the data from line stores 8 and 10, a correlation unit 26 performs a series of correlations on the data in line stores 22 and 24, i.e. the possible pixels to be used in reconstructing a missing pixel for field store 4. The results of these correlations are set to a best correlation selector 28 which selects the correlation most likely to give the best result. For example, this could be the lowest SAD correlation. The output of the best correlation selector 28 is then used by an interpolation scheme selection 30 to select an interpolation scheme corresponding to the best correlation. This interpolation scheme is then loaded into an interpolator 32 which receives data from line stores 22 and 24 after any appropriate delay 34 and performs the selected interpolation on data from line stores 22 and 24 to produce data for the missing pixel. This occurs for each pixel in turn, substantially at the same time as the process operating on data from field store 4.

The results from the interpolators 18 and 32 are fed to a further interpolator 34. This performs an interpolation between the two interpolated pixels to derive an output pixel which is provided to a frame store 36 which also receives data from line store 10 corresponding to the known lines of the current field for each field in turn. Once this frame store is full, the resultant video signal can be sent to a display 38 or can be stored.

Preferably the whole process takes place in real time so that it can be performed on a video signal being received by a television receiver which converts the signal into a non-interlaced form ready for display.

Preferably, the system of FIG. 6 is included in a television receiver so that new receivers including this system can display a higher resolution version of an interlaced signal.

In an improvement on the arrangement of FIG. 6, two or more sets of the hardware be provided operating in parallel on different lines of the field stores 2, 4, and 6 to improve processing speed.

In an alternative, the system FIG. 6 can be implemented in a dedicated processor. Two or more dedicated processors can be provided in parallel to improve the speed of processing. One possibility is to have a processor available for each of the missing lines of the field in field store 20 to thereby minimise processing time. This of course would make the unit more expensive.

In an alternative to the arrangements of FIGS. 4 and 5, and consequently the system of FIG. 6, a four-input correlation could be made between vertically adjacent pixels and temporally adjacent pixels for a number of different possible interpolations between these pixels.

1. A method for converting an interlaced video signal to a non-interlaced video signal comprising the steps of:
for each pixel in each missing line of a video field in a video signal deriving correlation data for each of a set of possible interpolators to be used in reconstructing the pixel in the missing line;
selecting a correlation corresponding to the interpolation likely to give the best result for the missing pixel; and
selecting an interpolation scheme for the pixel in the missing line in dependence on the selected correlation; and
interpolating the pixel in the missing line with the selected interpolation scheme;
wherein the step of deriving correlation data comprises deriving correlation data from the field containing the missing line and from adjacent fields.

2. A method according to claim 1 in which the step of deriving correlation data for each of a set of possible interpolation schemes comprising deriving correlation data from pixels in the same field as the pixel in the missing line, and deriving correlation data from fields temporally spaced from that field.

3. A method according to claim 2 in which the step of deriving correlation data from pixels in the same field comprises deriving a set of correlation data each correlation in the set corresponding to a different interpolation scheme.

4. A method according to claim 2 in which the step of deriving correlation data from temporally spaced fields comprises deriving a set of correlation data each correlation in the set corresponding to a different interpolation scheme.

5. A method according to claim 3 in which the step of selecting an interpolation scheme comprising selecting a first interpolation scheme from the set of correlation data derived from pixels in the same field, and second interpolation scheme from the set of correlation data derived from temporally spaced fields.

6. A method according to claim 5 in which the step of interpolating the pixel in the missing line comprises interpolating the first pixel data with the first selected interpolation scheme, interpolating the second pixel data with the second selected interpolation scheme, and interpolating the pixel in the missing line from the first and second pixel data.

7. A method according to claim 1 including the step of deriving a set of correlation data points corresponding to data points to be used in interpolating a pixel in a missing line of a video signal, the set of correlation data points being derived from contributions from pixels in a current field containing the missing line and from pixels in temporally spaced fields.

8. A method according to claim 7 in which at least four correlation data points are derived for each pixel in a missing line.

9. Apparatus for converting an interlaced video signal to a non-interlaced video signal comprising:
means which for each pixel in each missing line of a video field in a video signal derives correlation data for each of a set of interpolations to be used in reconstructing the pixel in a missing line;
means for selecting a correlation corresponding to the interpolation likely to give the best result for the missing pixel;
means for selecting an interpolation scheme for the pixel in the missing line in dependence on the selected correlation; and
means for interpolating the pixel in the missing line with the selected interpolation scheme;
wherein the means for deriving correlation data comprises means for deriving correlation data from the field containing the missing line and from adjacent fields.

10. Apparatus according to claim 9 in which the means for deriving correlation data for each of the set of possible interpolation schemes comprises means for deriving correlation data from pixels in the same field as the pixel in the missing line, and means for deriving correlation data from fields temporally spaced from that field.

11. Apparatus according to claim 10 in which the means for deriving correlation data from pixels in the same field comprises means for deriving a set of correlation data, each correlation in the set corresponding to a different interpolation scheme.

12. Apparatus according to claim 10 in which the means for deriving correlation data from temporally spaced fields comprises means for deriving a set of correlation data, each correlation in the set corresponding to a different interpolation scheme.

13. Apparatus according to claim 11 in which the means for selecting an interpolation scheme comprises means for selecting the first interpolation from the set of correlation data derived from pixels in the same field, and a second interpolation scheme from the set of correlation data derived from temporally spaced fields.

14. Apparatus according to claim 13 in which the means for interpolating the pixel in the missing line comprises means for interpolating first pixel data with the first selected interpolation scheme, means for interpolating second pixel data with the second selected interpolation scheme, and means for interpolating the pixel in the missing line from the first and second pixel data.

15. Apparatus according to claim 9 including means for deriving a set of correlation data points corresponding to data points to be used in interpolating a pixel in a missing line on a video signal, the set of correlation data points derived from contributions from pixels in a current field containing the missing line and from pixels in temporally spaced fields.

16. Apparatus according to claim 9 in which the means for deriving a set of correlation data points derives at least four correlation data points for each pixel in a missing line.

17. (canceled)

18. Apparatus for converting an interlaced video signal to a non-interlaced video signal substantially as herein described with reference to FIG. 6 of the drawings.
